(19) United States
(12) Patent Application Publication
(10) Pub. No.: US 2010/0146209 A1
(43) Pub. Date: Jun. 10, 2010

(54) METHOD AND APPARATUS FOR COMBINING INDEPENDENT DATA CACHES

(75) Inventors: Doug Burger, Austin, TX (US); Stephen W. Keckler, Austin, TX (US); Changkyu Kim, San Jose, CA (US)

Correspondence Address: DORSEY & WHITNEY LLP;INTELLECTUAL PROPERTY DEPARTMENT, 250 PARK AVENUE, NEW YORK, NY, 10177, US

(73) Assignee: Intellectual Ventures Management, LLC, Bellevue, WA (US)

(21) Appl. No.: 12/329,530

(22) Filed: Dec. 5, 2008

(51) Int. Cl. G06F 12/08

(52) U.S. Cl. 711/120; 711/122; 711/E12.043

(57) ABSTRACT

Methods, apparatus, computer programs and systems related to combining independent data caches are described. Various implementations can dynamically aggregate multiple level-one (L1) data caches from distinct processors together, change the degree of interleaving (e.g., how much consecutive data is mapped to each participating data cache before addresses go on to the next one) among the cache banks, and retain the ability to subsequently adjust the number of data caches participating as one coherent cache, i.e., the degree of interleaving, such as when the requirements of an application or process change.

### STATEMENT REGARDING GOVERNMENT SPONSORED RESEARCH

The invention was made with the U.S. Government support, at least in part, by the Defense Advanced Research Projects Agency, Grant number F33615-03-C-4106. Thus, the U.S. Government may have certain rights to the invention.

### BACKGROUND

Data memory accesses are one of the single largest components of performance loss in modem microprocessor systems. Currently, Level 1 (L1) data caches in distinct processors on a multi-core chip typically exist as separate coherence units entirely, with no possibility of acting as a single logical memory system, nor do they offer the flexibility of adaptive interleaving since they operate autonomously. Although there has been some prior work done in configuring Level 2 (L2) cache in multi-core processing environments, current multi-core, which include composable lightweight processor (CLP) technologies use fixed L1 data caches that have not been dynamically configurable.

### BRIEF DESCRIPTION OF THE FIGURES

The features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

FIG. 1 shows an example of a hardware configuration of a computer system configured for combining independent data caches;

FIG. 2 is a simplified block diagram illustrating an example of a processor of the computer system shown in FIG. 1 configured for combining independent data caches;

FIGS. 3a and 3b are diagrams showing two possible configurations for a multi-core processor, illustrating example methods for combining and dynamically reconfiguring independent data caches;

FIG. 4 is flowchart illustrating examples of the logical flow involving various hit and miss possibilities that can occur in various implementations of a method for combining independent data caches; and

FIGS. 5a-5d are diagrams that illustrate four examples of varying degrees of cache interleaving versus cache coherence that can be dynamically configured, all arranged in accordance with the present disclosure.

### DETAILED DESCRIPTION

In the following detailed description, reference is made to the accompanying drawings, which form a part hereof. In the drawings, similar symbols typically identify similar components, unless context dictates otherwise. The illustrative examples described in the detailed description, drawings, and claims are not meant to be limiting. Other examples may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly and implicitly contemplated and made part of this disclosure.

The various aspects, features, examples, embodiments or implementations of the invention described herein can be used alone or in various combinations. The methods of the present invention can be implemented by software, hardware or a combination of hardware and software.

The present application is drawn, inter alia, to methods, apparatus, computer programs and systems related to combining independent data caches. The disclosure describes examples of the construction and operation of hardware memory systems that are more flexible, so that a given design can be configured to match the needs of an application, resulting in greater power efficiency and performance.

Various implementations described herein can dynamically aggregate multiple level-one (L1) data caches associated with distinct processors, change the degree of interleaving (e.g., how much consecutive data is mapped to each participating data cache before addresses go on to the next one), and retain the ability to subsequently adjust the number of participating data caches, or the degree of interleaving, when the requirements of an application or computer process change. For example, utilizing a single chip multiprocessor with 32 processors, each with its own 16 KB level one data cache, if an application would work best with a 64 KB level-one data cache (i.e., 64 KB is the size of its primary working set), employing the present systems and methods, four of the processor/caches can be logically grouped together, giving the view of a single logical 64 KB data cache. Thus, the four participating L1 caches can act as a single coherence unit. In addition, the system may determine that it is best to have an interleaving degree, such as 2 cache lines, where addresses map to one cache for 128 bytes (assuming 64 B cache lines), and then to the next cache for the next 128 bytes of the address space, and so on.

At some point, a reconfiguration of the allocation and coherence of the L1 caches may be desirable. For example, the working set may have grown too large for the current configuration, e.g., just under 100 KB. At such point, the system may interrupt the running jobs and add additional processor/data cache combinations. For example, if four more processor/data cache combinations were added, this would bring the logical total of L1 data cache to 128 KB. Since the number of participating caches has changed, the cache lines in the caches now map to different physical L1 cache banks but should preferably be kept coherent. When this example of a reconfiguration occurs, accesses to cache line X (where X is used to designate an arbitrary address) may now be directed to the wrong cache, and X may be modified in another cache bank. As a result, the new cache that should own X “misses” on an attempt to access the L1 cache. Should this occur, the chip-level coherence protocol will act to invalidate the old copy and permit the new cache to hold X and continue. Each individual cache is treated as a separate entity from the coherence protocol's point of view, even when they are configured to cooperate as a single logical unit.

Various implementations for combining independent data caches, including L1 data caches, can be applied to alter the number of banks existing as a single coherence unit, as well as to change the degree of interleaving among the banks participating as a single coherence unit. This permits multiple cache banks in a large distributed microprocessor to dynamically vary the degree of interleaving among cache banks and the coherence interactions among cache banks by writing to control registers. This dynamic capability allows, for example, multiple independent processors that are colluding on a single program to share the multiple level-one data caches, without needing to flush those data caches upon a reconfiguration in which the number of participating cores is changed. Additionally, in various example implementations, the degree of interleaving of the data caches may be set to best align the locality access patterns of the running application with the selected hardware configuration itself.

The figures include numbering to designate illustrative components of examples shown within the drawings, including the following: a computer system 100, a processor 101, a system bus 102, an operating system 103, an application 104, a read-only memory 105, a random access memory 106, a disk adapter 107, a disk unit 108, a communications adapter 109, an interface adapter 110, a display adapter 111, a keyboard 112, a mouse 113, a speaker 114, a display monitor 115, L1 data cache 121, fetch unit 201, Instruction Fetch Address Register 202, Instruction Cache (I-Cache) unit 203, Instruction Dispatch Unit (IDU) 204, instruction sequencer 205, instruction window 206, fixed point units 207, load/store units 208, floating point units 209, General Purpose Register (GPR) file 210, Floating Point Register (FPR) file 212, completion unit 214, Bus Interface Unit (BIU) 216, system memory 217, integrated circuit chip 301, processor cores 310-317, individual L1 cache 320-327, threads 330-334, L2 cache 350, cache block 351, data entry 353, tag 355, directory 356, directory entry 357, bit vector 360, bit 361, L2 cache line 362, address of a cache line 363, composed processors 370, 372 and 380, and cache manager 390.

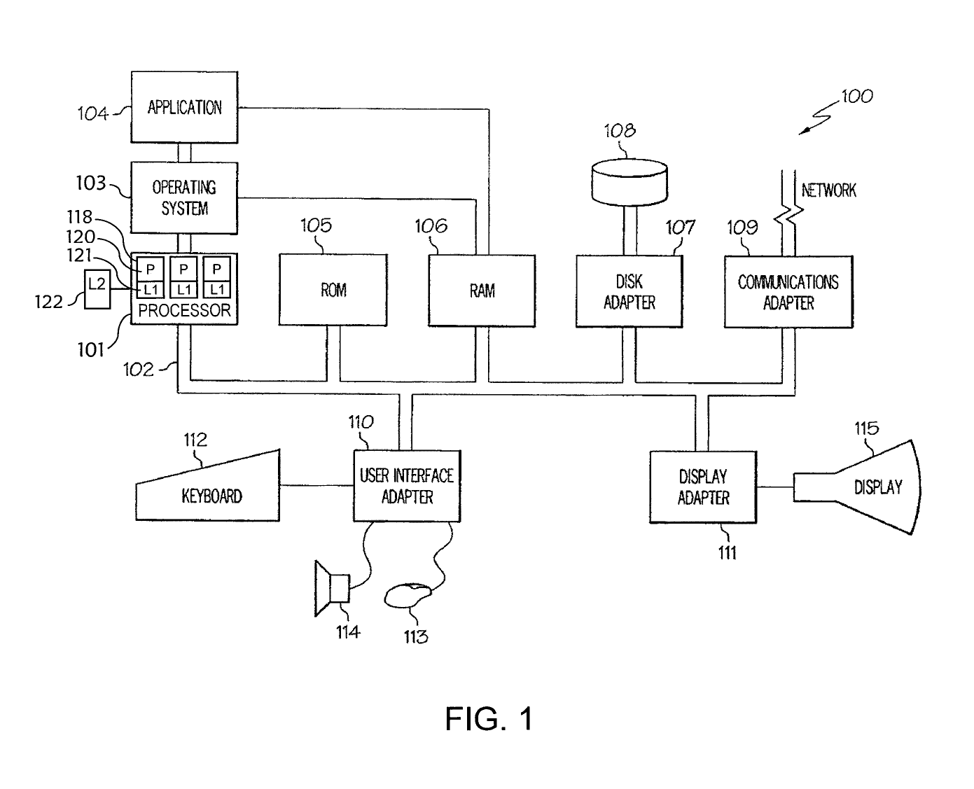

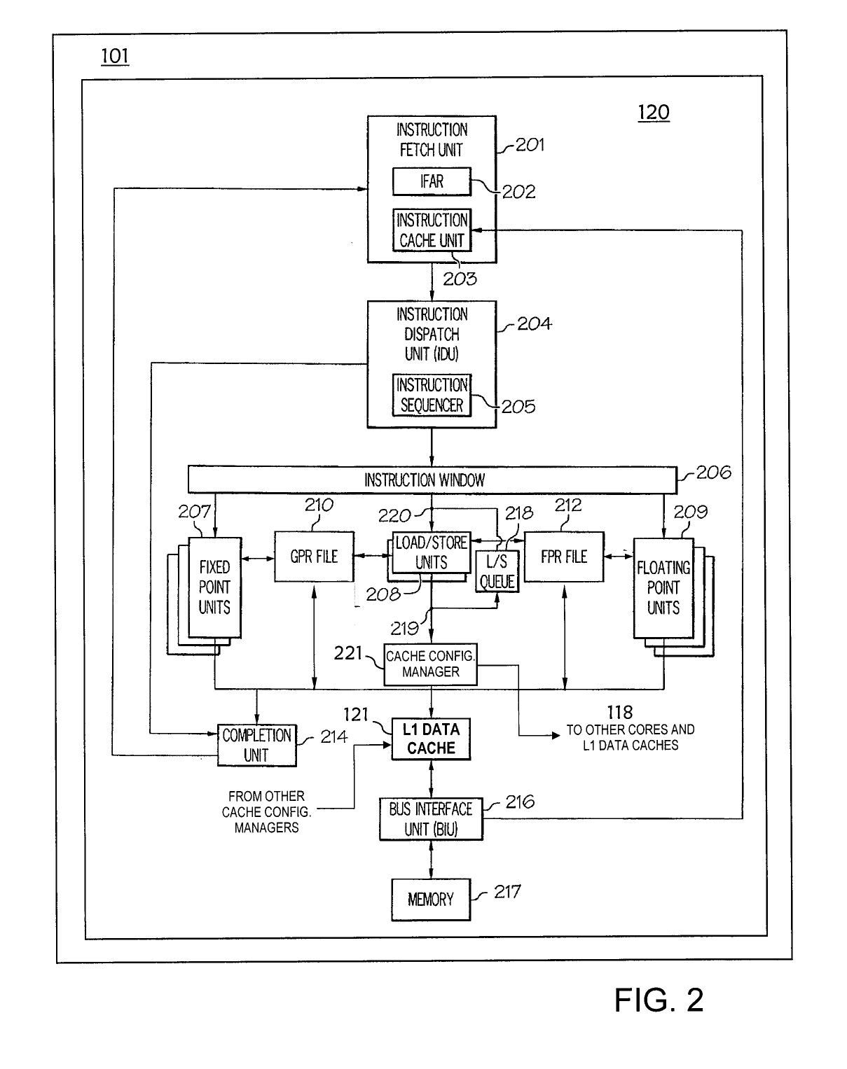

FIG. 1 shows an example of a hardware configuration of a computer system 100 configured for combining independent data caches. Although not limited to any particular hardware system configuration, FIG. 1 illustrates an example computer system 100 that includes a processor 101 that is typically coupled to various other components by system bus 102. Processor 101 can be a multi-core processor and may include a number of processing cores 118, each having associated processors 120 and corresponding L1 caches 121. As is well understood in the art, the multiple processing cores 118 are interconnected and interoperable, such as by an on-chip network (not shown in FIG. 1). A more detailed description of processor 101 is provided below in connection with FIG. 2. Referring to FIG. 1, an operating system 103 may run on processor 101 to provide control and coordinate the functions of the various components of FIG. 1. An application 104 that is arranged in accordance with the principles of the present disclosure may run in conjunction with operating system 103 and may provide calls to operating system 103 where the calls implement the various functions or services to be performed by application 104.

Referring to FIG. 1, read-only memory (“ROM”) 105 may be coupled to system bus 102 and include a basic input/output system (“BIOS”) that controls certain basic functions of computer device 100. Random access memory (“RAM”) 106 and disk adapter 107 may also be coupled to system bus 102. It should be noted that software components including operating system 103 and application 104 may be loaded into RAM 106, which may be the computer system's main memory for execution. Disk adapter 107 may be an integrated drive electronics (“IDE”) adapter (aka Parallel Advanced Technology Attachment or “PATA”) that communicates with a disk unit 108, e.g., disk drive, or any other appropriate adapter such as a Serial Advanced Technology Attachment (“SATA”) adapter, a universal serial bus (“USB”) adapter, a Small Computer System Interface (“SCSI”), to name a few.

Computer system 100 may further include a communications adapter 109 coupled to bus 102. Communications adapter 109 may interconnect bus 102 with an outside network (not shown) thereby allowing computer system 100 to communicate with other similar devices. I/O devices may also be connected to computer system 100 via a user interface adapter 110 and a display adapter 111. Keyboard 112, mouse 113 and speaker 114 may all be interconnected to bus 102 through user interface adapter 110. Data may be inputted to computer system 100 through any of these devices. A display monitor 115 may be connected to system bus 102 by display adapter 111. In this manner, a user is capable of interacting with the computer system 100 through keyboard 112 or mouse 113 and receiving output from computer system 100 via display 115 or speaker 114.

FIG. 2 is a simplified block diagram illustrating an example of a processor 101 of the computer system shown in FIG. 1 configured for combining independent data caches. FIG. 2 illustrates that an example processor can be configured to be used with the presently disclosed methods for combining data caches, including but not limited to L1 caches. Processor 101 may include an instruction fetch unit (IFU) 201 configured to fetch an instruction in program order. IFU 201 may further be configured to load the address of the fetched instruction into Instruction Fetch Address Register (“IFAR”) 202. The address loaded into IFAR 202 may be an effective address representing an address from the program. The instruction corresponding to the received effective address may be accessed from Instruction Cache (I-Cache) unit 203 comprising an instruction cache (not shown) and a prefetch buffer (not shown). The instruction cache and prefetch buffer may both be configured to store instructions. Instructions may be inputted to instruction cache and prefetch buffer from a system memory 217 through a Bus Interface Unit (BIU) 216.

Instructions from I-Cache unit 203 may be outputted to Instruction Dispatch Unit (IDU) 204. IDU 204 may be configured to decode these received instructions. IDU 204 may further comprise an instruction sequencer 205, configured to forward the decoded instructions in an order determined by various algorithms. The out-of-order instructions may be forwarded to one of a plurality of issue queues, or what may be referred to as an “instruction window” 206, where a particular issue in instruction window 206 may be coupled to one or more particular execution units, fixed point units (FXUs) 207, load/store units (LSUs) 208 and floating point units (FPUs) 209. Instruction window 206 includes all instructions that have been fetched but are not yet committed. Each execution unit may execute one or more instructions of a particular class of instructions. For example, FXUs 207 may execute fixed point mathematical and logic operations on source operands, such as adding, subtracting, ANDing, ORing and XORing. FPUs 209 may execute floating point operations on source operands, such as floating point multiplication and division.

As stated above, instructions may be queued in one of a plurality of issue queues in instruction window 206. If an instruction contains a fixed point operation, then that instruction may be issued by an issue queue of instruction window 206 to any of the multiple FXUs 207 to execute the instruction containing the fixed point operation. Further, if an instruction contains a floating point operation, then that instruction may be issued by an issue queue of instruction window 206 to any of the multiple FPUs 209 to execute the instruction containing the floating point operation.

All of the execution units, FXUs 207, FPUs 209, LSUs 208, may be coupled to completion unit 214. Upon executing the received instruction, the execution units, FXUs 207, FPUs 209, LSUs 208, may transmit an indication to completion unit 214 indicating the execution of the received instruction. This information may be stored in a table (not shown) which may then be forwarded to IFU 201. Completion unit 214 may further be coupled to IDU 204. IDU 204 may be configured to transmit to completion unit 214 the status information (e.g., type of instruction, associated thread, etc.) of the instructions being dispatched to instruction window 206. Completion unit 214 may further be configured to track the status of these instructions. For example, completion unit 214 may keep track of when these instructions have been committed. Completion unit 214 may further be coupled to instruction window 206 and further configured to transmit an indication of an instruction being committed to the appropriate issue queue of instruction window 206 that issued the instruction that was committed.

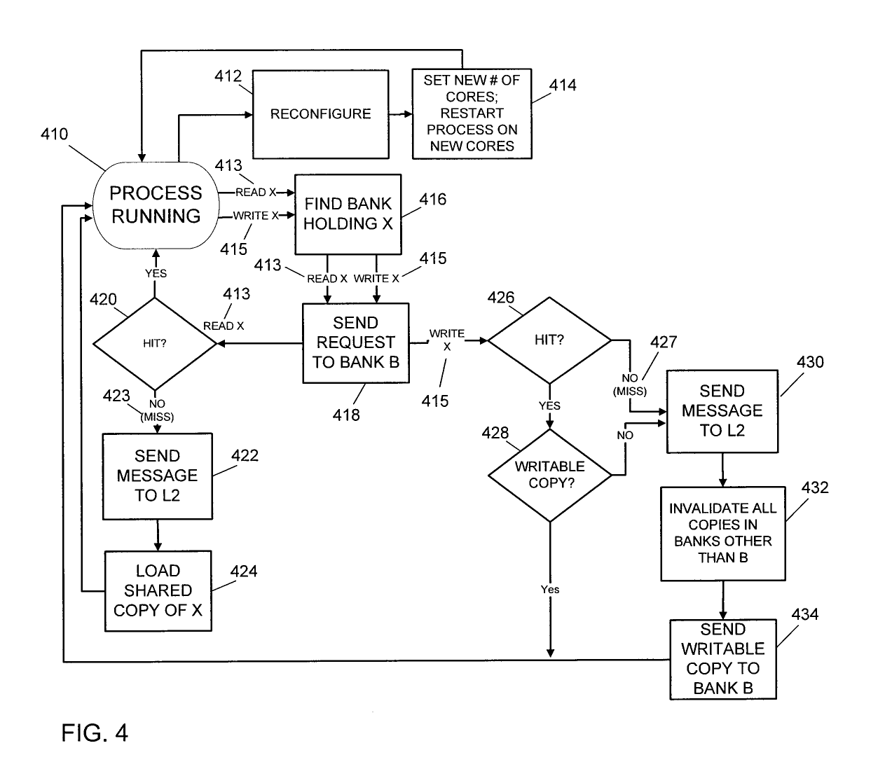

In various implementations, LSUs 208 may be coupled to a L1 data cache 121 by way of a cache configuration manager 221. The cache configuration manager operates to establish the desired interleaving between and among shared L1 cache across multiple processing cores. The cache configuration manager is coupled to local L1 data cache 121 and other L1 data cache, such as via an on-chip network among processor cores 118. For example, as explained further in connection with FIG. 4, the cache configuration manager can use the cache block address and the number of cores being composed to apply a hash function that picks the core number to where the block is mapped. Although shown in this example as an operating unit within processing core 120, it will be appreciated that the cache configuration manager can be distributed among several cores or even be performed independently of one or more processing cores.

In response to a load instruction, LSU 208 inputs information from L1 data cache 121 and copies such information to one or more selected GPR files 210 and/or FPR files 212. If such information is not stored in L1 data cache 121, then L1 data cache 121 inputs through Bus Interface Unit (BIU) 216 such information from system memory 217 connected to system bus 102 (See FIG. 1). Moreover, L1 data cache 121 may be able to output through BIU 216 and system bus 102 information from L1 data cache 121 to system memory 217 and/or L2 cache connected to system bus 102, for example. L2 cache can also be included in or directly connected to processor 101. In response to a store instruction, LSU 208 may input information from a selected one of GPR file 210 and FPR file 212 and copy such information to L1 data cache 121 when the store instruction commits.

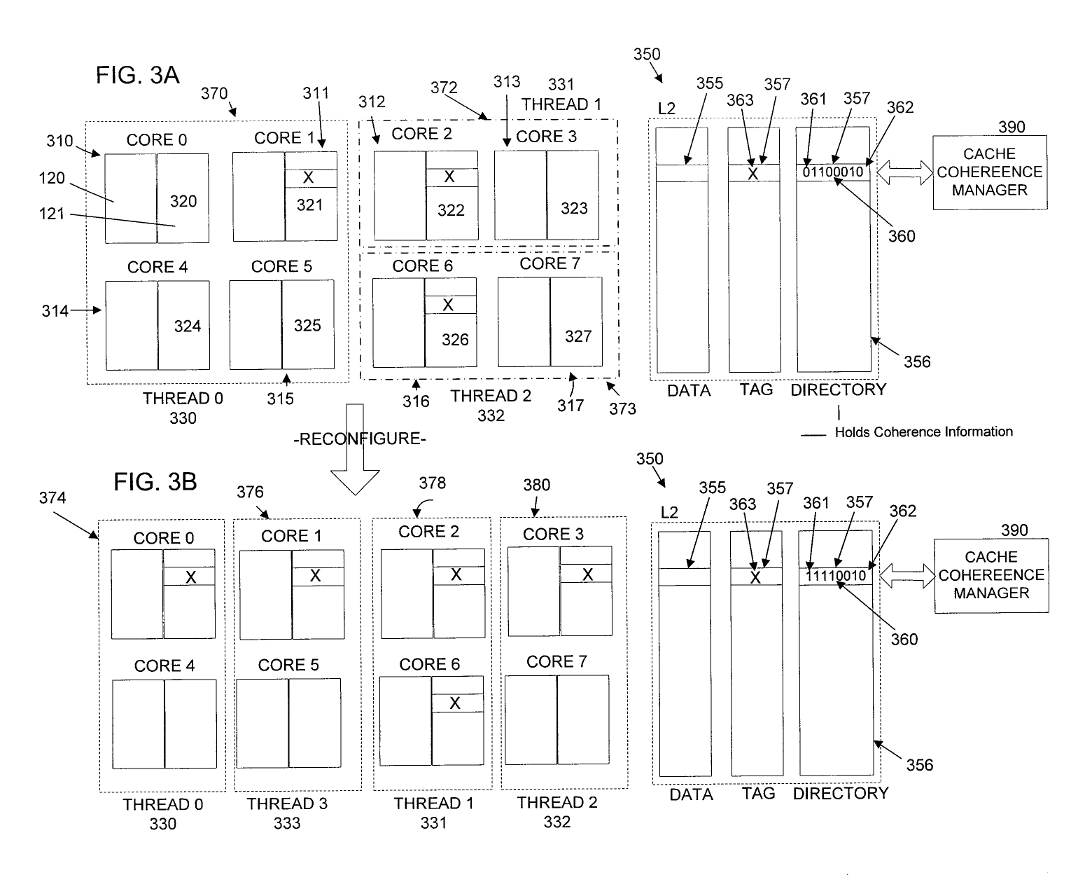

FIGS. 3a and 3b are diagrams showing two possible configurations for a multi-core processor, illustrating example methods for combining and dynamically reconfiguring independent data caches. FIG. 3a illustrates multi-core processors that can be implemented as a single integrated circuit chip 301, having eight processor cores 310, 311, 312, 313, 314, 315, 316, 317 (Core “0” 310 through Core “7” 307). Each processor core has an associated individual L1 cache 320, 321, 322, 323, 324, 325, 326, 327, which correspond to cores 310, 311, 312, 313, 314, 315, 316, 317, respectively. In FIG. 3a, the processor cores are illustrated as being arranged as three composed processors currently running three threads (e.g., independent sequences of execution in a program). As illustrated, thread “0” 330 is running on composed processor 370 that includes core “0” 310, core “1” 311, core “4” 314, and core “5” 315. Thread “1” 331 is running on composed processor 372, that includes core “2” 312 and core “3” 313. Thread “2” 332 is running on composed processor 373, that includes core “6” 316 and core “7” 317.

Also shown in FIG. 3a, as being included on chip 301 in this example, is a L2 cache 350. L2 cache 350 also or alternatively can be externally connected to chip 301. L2 cache 350 can include a cache block 351 corresponding to each core 310, 311, 312, 313, 314, 315, 316, 317 (Core “0” through Core “7”). For each cache block 351, L2 cache 350 can have a data entry 353, a tag 355, and a directory entry 357 containing a bit vector 360. The bit vector, which is described in further detail below, stores the coherence information for determining which L1 caches are storing the line associated with that coherence manager. Distributed control information in each processor core determines which L1 data caches are treated as distributed interleaved caches and which L1 data caches are in separate coherence units. The value of the bit vector is determined by a cache coherence manager 390. Cache coherence manager 390 can be hardware and/or software, and can be located on chip 301 and/or located in other parts of a system, such as, for example, within an operating system. In some examples, the bit vector 360 for each cache block 351 in the L2 cache 350 can hold one bit 361 for each core 310, 311, 312, 313, 314, 315, 316, 317. Thus, in this example, each L2 cache line 362 can have an eight-bit directory entry 355 in the directory 356. It will be understood that for a processor having N processing cores, the bit vector can be expanded to N bits.

As illustrated in FIGS. 3a and 3b, in this example, “X” 363 represents an address of a cache line 362. Each bit 361 in the bit vector 360 belonging to cache line 362 is set if the particular core corresponding to bit 361 may have a copy of X 363 in its L1 cache. Typically, each bit 361 is set for a core when the core caches the copy, but the copy may be evicted silently without each bit 361 being cleared. For example, if thread “0” 330 wants to write to a shared copy of cache line 362 in its cache, it sends the store to the core in the composed processor that X is mapped to. In the current example, this is core “1” 311. This will result in a look up of X, which will result in thread “0” having a “hit” to this cache, but also finding that the line is shared. The core then sends an upgrade request to the L2 cache 350, which accesses the bit vector 360 and sends an “invalidate X” message to every core for which the bit has been set other than the requestor. When every core 310, 311, 312, 313, 314, 315, 316, 317 returns a message acknowledging that their respective invalidation has been completed, the L2 cache 350 then can send permissions to core “1” 311 to allow the write operation to complete in cache line 362.

FIG. 3b shows an example of a reconfiguration operation of the processing cores previously configured as composed processors 370, 372 shown in FIG. 3a. In this example, a new thread (Thread “3”) 333 is introduced which triggers a reconfiguration of the composed processors and cache configuration. Upon the arrival of Thread “3” 333, this thread is allocated a newly configured composed processor 376, including core “1” 311 and core “5” 315. The operating system then reduces the size of the composed processor running Thread “0” 330 down to core “0” 310 and core “4” 314. Thread “1” 331 is remapped from composed processor 372, to a newly configured composed processor 378, which includes core “2” 312 and core “6” 316. Similarly, Thread “2” is remapped from composed processor 373 to composed processor 380 that includes core “3” 313 and core “7” 317.

Previously, the cache in core “0” or core “4” did not have a copy of X. Thus, when Thread “0” attempts to read X, there is a miss, but it is serviced by L2 cache 350, and X is loaded into the L1 data cache for core “0”. However, X remains (until a happenstance eviction) in the L1 data cache for core “1”, even though Thread “3” 333 does not access X. In this example, the same applies for Thread “2” 332 loading X into the L1 data cache for core “3”.

Example bit vectors for X's L2 directory entry 357 are shown before (e.g., as shown in FIG. 3a) and after (e.g., as shown in FIG. 3b) the reconfiguration and relevant accesses to X. The value of these examples of bit vectors 361 provided by cache manager 390 are 01100010 and 11110010, respectively. Another reconfiguration can occur when, for example, Thread “0” 330 writes X and invalidates all copies but for the copy residing in Core “0” 310. After such a reconfiguration, the cache manager 390 generates a new bit vector 10000000.

One feature of various present implementations for combining independent data caches is that typically, the chip-level cache coherence protocol utilized for combining independent data caches disclosed herein can naturally reconcile the changed cache mappings over time, for example. This is generally the case regardless of the configuration that is chosen for an arbitrary number of threads, whether or not the threads share a cache line. Cache lines in “stale” mapping places will eventually get replaced or invalidated by the cache coherence protocol, and cache lines mapping to new locations will simply miss and fill the cache line in the newly mapped bank, regardless of to where the mapping was before the change of cache mappings. This capability can reduce the need to flush the data cache and/or move cache lines around proactively upon a reconfiguration, making reconfigurations of composed cores simpler than would be without this capability, for example.

FIG. 4 is flowchart illustrating examples of the logical flow involving various hit and miss possibilities that can occur in various implementations of a method for combining independent data caches. The hit and miss possibilities can occur either before or after a reconfiguration occurrence of L1 cache. Starting with step 410 (Process Running), a process is running on a composed processor (e.g., 101, 301), and either a cache request or a reconfiguration command may be issued. In step 412 (Reconfigure), a reconfiguration command is issued and executed, such as when a thread has arrived or completed. Upon completion of reconfiguration, the process continues to step 414 (Set New # of Cores; Restart Process on New Cores), in which the control registers specifying what cores are assigned to each thread, the number of cores assigned to each thread, and the topology of the processor with respect to the cores, cores are changed for every core in which a thread is involved. The process then returns to step 410.

If, in step 410, instead of a reconfiguration occurring, a read command (e.g., Read X) 413 and/or a write command (e.g., Write X) 415 is issued, the process goes to step 416. In step 416 (Find Bank Holding X), the cache configuration manager can use the cache block address and the number of cores being composed to apply a hash function that picks the core number to where the block is mapped. This can depend on how many interleaved caches are composed together to form a single logical banked cache. Upon identifying the core number to where the block is mapped, e.g., core B in step 416, the read command (e.g., Read X) 413 and/or write command (e.g., Write X) 415 is sent to core B in step 418 (Send Request to Bank B). For a read command 413, the process then advances to step 420 (Hit?), where the method inquires whether there is a read hit to the L1 cache. If, in step 420, there is a read hit, the process returns to step 410. If, in step 420, there is not a read hit but rather a read miss 423, the process goes to step 422 (Send Message to L2), in which the method sends a message to L2 cache. The process then proceeds to step 424 (Load Shared Copy of X), in which the method loads a shared copy of X before returning to step 410.

For a write command (e.g., Write X) 415, the process, after step 418, goes to step 426 (Hit?), where the method determines whether there is a write hit. If there is a write hit, the process proceeds to step 428 (Writable Copy?) where the method inquires whether there is a writable copy, e.g., if the cache line is in shared (i.e. read-only) state. If there is a writable copy, the process returns to step 410. If there is not a writable copy, the process goes to step 430 (Send Message to L2), in which a message is sent to L2 cache. The process the proceeds to step 432 (Invalidate All Copies in Banks Other than B), in which the method launches an invalidation procedure to invalidate all copies in banks not located in the core to where the block is mapped (e.g., core B). The process then proceeds to step 434 (Send Writable Copy to Bank B), in which a writable copy (and/or permission) is sent to the requesting core before returning to step 410. If, in step 426, there is not a hit but rather a write miss, then the process proceeds to steps 430, 432 and 434, described above. In this example, upon a read/load miss in step 420, the method does not have to perform all of the steps associated with a write miss, but rather can just send a message to the L2 cache in step 422 and a shared copy of X can be loaded in step 424.

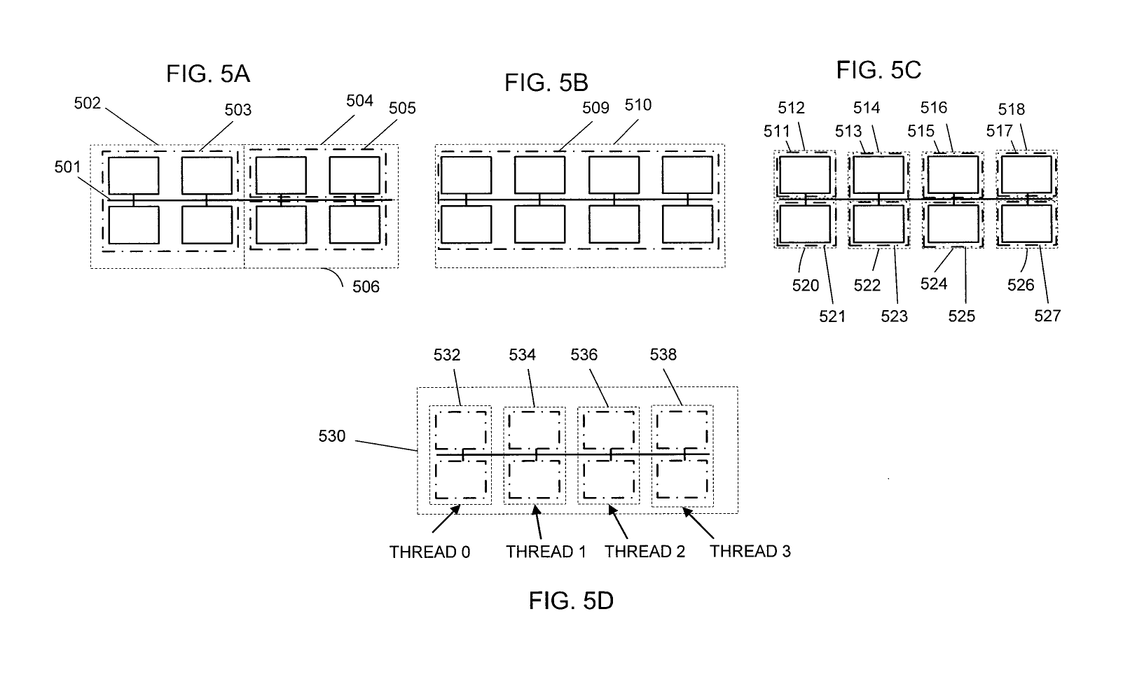

FIGS. 5a-5d are diagrams that illustrate four examples of varying degrees of cache interleaving (i.e., sharing of cache within a cache domain) and cache coherence that can be dynamically configured in accordance with the present disclosure. In particular, the present ability to independently configure composed multiprocessor domains and cache interleaving and coherence domains is illustrated in FIGS. 5a-5d. FIG. 5a illustrates an example in which eight processing cores and associated L1 cache 310, 311, 312, 313, 314, 315, 316, and 317 that are interoperable, such as by way of a conventional on-chip network 501. Referring to FIG. 5a, the processing cores are configured with three composed processors 502, 504, 506, balancing interleaved and coherence domains. In this example, three threads are given with each thread running on corresponding individual composed processors 502, 504, 506. FIG. 5a further illustrates that, in this example, the cache domains 503, 505 and 507 are configured to correspond to the composed processors 502, 504, 506. In other words, composed processor 502 includes four processing cores 310, 311, 314 and 315 and the cache domain 503 is configured to provide interleaving among the L1 cache of these same four cores. Similarly, composed processor 504 is a second composed processor including cores 312 and 313 and share L1 cache among these two processing cores. Thus, the cache domain 503 is interleaved for processing cores of composed processor 502, but this cache domain is coherent with respect to cache domain 505, that is associated with composed processor 504. Similarly, cache domain 507 provides interleaving among the L1 cache of processing core 316 and 317 but is coherent with respect to cache domains 503 and 505. In this way, the individual composed processors 502, 504, 506, can make use of the relatively limited domain by aggregating/interleaving their independent caches logically.

FIG. 5b illustrates an example of a strategy that assumes that large working sets are common, and so the entire array of processing cores are shared as one composed processor 510 and a corresponding cache domain 509 in which the L1 cache of all processing cores 310, 311, 312, 313, 314, 315, 316 and 317 are interleaved. All of associated threads are shared as well, which reduces L2 cache misses, coherence, etc., but there can be extra routing for a processor to get to the cache bank within the interleaved domain that it needs. FIG. 5c illustrates the case where all threads are in their own cache domain, and there is no sharing of processing cores or cache banks among any processing cores. In other words, each processor 512, 514, 516, 518, 520, 522, 524 and 526 is an independent processing domain and the associated L1 cache are independent cache domains 511, 513, 515, 517, 521, 523, 525, 527. FIG. 5d illustrates an example wherein the processing cores are arranged as four composed processors 532, 534, 536, 538 with the four composed processors all sharing a single cache domain 530. Thus, the interleaving is shared within the L1 caches of all eight processing cores. Each of the caches are interleaved in a common cache domain 530 and not in separate coherence domains, even though there are multiple threads running on four composed processors 532, 534, 536, and 538. Thus, while there are four composed processors, each processor core can access the L1 cache of any other processor in the cache domain 530.

It will be appreciated that the examples in FIGS. 5a-5d are only a small number of possible examples and a variety of configurations are possible. For example, multiple processing cores can be grouped as a composed processor without sharing the individual L1 cache. Thus, each processing core would have its own cache domain even though it was operating in a shared processing domain. In another example, it is also possible for a processing core in a composed processor to be idle and have its cache available to other cores in a shared cache domain.

Examples of various implementations for combining independent data caches described herein can be utilized in the TFlex microarchitecture, for example. The TFlex microarchitecture is a Composable Lightweight Processor (CLP) that allows simple cores, which can also be called tiles, to be aggregated together dynamically. TFlex is a fully distributed tiled architecture of 32 cores, with multiple distributed load-store banks, that supports an issue width of up to 64 and an execution window of up to 4096 instructions with up to 512 loads and stores. Since control decisions, instruction issue, and dependence prediction may all happen on different tiles, for example, a distributed protocol for handling efficient dependence prediction should be used.

The TFlex architecture uses the TRIPS Explicit Data Graph Execution (EDGE) instruction set architecture (ISA), which can encode programs as a sequence of blocks that have atomic execution semantics, meaning that control protocols for instruction fetch, completion, and commit can operate on blocks of up to 128 instructions. The TFlex CLP microarchitecture can allow the dynamic aggregation of any number of cores—up to 32 for each individual thread—to find the best configuration under different operating targets: e.g., performance, area efficiency, or energy efficiency. The TFlex microarchitecture has no centralized microarchitectural structures. Structures across participating cores can be partitioned based on address. Each block can be assigned an owner core based on its starting address (PC). Instructions within a block can be partitioned across participating cores based on instruction IDs, and the load-store queue (LSQ) and data caches can be partitioned based on load/store data addresses, for example.

Various implementations for combining independent data caches may be applicable to any architecture with distributed fetch and distributed memory banks. For example, various implementations for combining independent data caches may be adapted and/or configured for use with Core Fusion™ by giving its steering management unit (SMU) the responsibilities of the controller core. In addition, while the block-atomic nature of the ISA used by TFlex generally can simplify at least some components of various implementations of a method for combining independent data caches described herein, this technique can be employed with other ISAs by artificially creating blocks from logical blocks in the program to simplify store completion tracking, for example. TFlex is a particular CLP design that can achieve the composable capability by mapping large, structured instruction blocks across participating cores differently depending on the number of cores that are running a single thread.

A fully composable processor shares no structures physically among the multiple processors. Instead, a CLP utilizes distributed microarchitectural protocols and/or methods to provide the necessary fetch, execution, memory access/disambiguation, and commit capabilities. Full composability may be difficult in conventional ISAs because the atomic units are individual instructions, which require that control decisions be made too frequently to properly coordinate across a distributed processor. Explicit data graph execution (EDGE) architectures, conversely, can reduce the frequency of control decisions by employing block-based program execution and explicit intrablock dataflow semantics to map well to distributed microarchitectures, for example.

Some example methods for combining independent data caches include: providing a plurality of L1 cache banks associated with a plurality of processing cores; and configuring at least two of the plurality of cache banks to operate as a single coherent shared cache bank. The configuring step may include interleaving among the plurality of L1 cache banks operating as a single coherent shared cache. The methods may further include changing the degree of interleaving among the plurality of L1 cache banks operating as a single coherent shared cache. The methods may also further include the step of providing an L2 data cache, with the L2 data cache storing the coherence information for the at least two of the plurality of L1 cache banks. The coherence information stored in the L2 data cache can be in the form of at least one bit vector stored therein.

Some example apparatuses for combining independent data caches includes a memory system having at least two L1 data cache banks each associated with a processing core; and a cache manager for configuring at least two of said L1 data cache banks to operate as a single coherent shared cache bank. The cache manager can be configured to enable interleaving among at least two of the L1 cache banks operating as a single coherent shared cache bank. The cache manager can configure the cache to be capable of changing the degree of interleaving among the at least two of said L1 cache banks operating as a single coherent shared cache bank. Some example apparatus can include an L2 data cache that is adapted to store the configuration for the at least two of said plurality of L1 cache banks. The configuration stored in the L2 data cache can be in the form of at least one bit vector stored therein.

Some examples of multi-core processing arrangements include a plurality of processing cores that each has a processor and an L1 cache associated with the processor. Two or more of the L1 caches can be configurable to be shared with at least a second one of the processing cores. One or more L2 caches can be operatively coupled to the processing cores and the L1 cache or caches. Each L2 cache can be adapted to store coherence information of the configurable L1 cache. The coherence information may include at least one bit vector that may corresponding to each shared cache line. The processing cores and L1 cache can be provided on a single integrated circuit. The L2 cache can be provided on the single integrated circuit with the processing cores and L1 cache, for example.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (“ASICs”), Field Programmable Gate Arrays (“FPGAs”), digital signal processors (“DSPs”), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. For example, if a user determines that speed and accuracy are paramount, the user may opt for a mainly hardware and/or firmware vehicle; if flexibility is paramount, the user may opt for a mainly software implementation; or, yet again alternatively, the user may opt for some combination of hardware, software, and/or firmware.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive, a Compact Disc (“CD”), a Digital Video Disk (“DVD”), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for combining independent data caches comprising:
providing a plurality of L1 caches associated with a corresponding plurality of processing cores; and
configuring at least two of said plurality of caches that are associated with different cores to operate as a single coherent shared cache.

2. The method for combining independent data caches of claim 1, wherein the configuring step includes interleaving at least some of the plurality of L1 caches operating as a single coherent shared cache.

3. The method for combining independent data caches of claim 2, further comprising changing the degree of interleaving among the plurality of L1 caches to facilitate the operating as a single coherent shared cache for optimizing running of applications.

4. The method for combining independent data caches of claim 1, further comprising providing an L2 data cache that has stored coherence information for the at least two of said plurality of L1 caches.

5. The method for combining independent data caches of claim 4, wherein the coherence information stored in the L2 data cache comprises at least one bit vector stored therein.

6. An apparatus for combining independent data caches comprising:
a memory system having at least two L1 data caches and at least two processing cores, each of said at least two L1 data caches being associated with a corresponding one of the at least two processing cores; and
a cache configuration manager for configuring at least two of said L1 data caches to operate as a single coherent shared cache.

7. The apparatus for combining independent data caches of claim 6, wherein the cache manager is configured to be capable of interleaving among at least two of said L1 caches operating as a single coherent shared cache bank.

8. The apparatus for combining independent data caches of claim 6, wherein the cache manager is configured to be capable of changing the degree of interleaving among the at least two of said L1 caches operating as a single coherent shared cache bank.

9. The apparatus for combining independent data caches of claim 6, further comprising an L2 data cache, the L2 data cache being adapted to store the coherence information for the at least two of said plurality of L1 caches.

10. The apparatus for combining independent data caches of claim 9, wherein the coherence information stored in the L2 data cache comprises at least one bit vector stored therein.

11. The apparatus for combining independent data caches of claim 10, wherein the at least two L1 data cache comprise N data caches and wherein the at least one bit vector comprises N bits, with each bit corresponding to one of said N data caches.

12. The apparatus for combining independent data caches of claim 9, wherein the cache configuration manager specifies a hash function to determine the configuration, at least in part, by applying a hash function on a number of said processing cores.

13. A multi-core processing arrangement comprising:
a first processing core comprising a first processor and a first configurable L1 cache that is associated with the first processor;
a second processing core comprising a second processor and a second configurable L1 cache associated with the second processor, wherein the first configurable L1 cache and the second configurable L1 cache are configured to be shared with one or more of the first processing core and the second processing core;
an L2 cache operatively coupled to the first and second processing cores and also operatively coupled to the first and second L1 caches, wherein the L2 cache is arranged to store a configuration of the first and second configurable L1 caches.

14. The multi-core processing arrangement of claim 13, wherein the coherence information comprises a bit vector.

15. The multi-core processing arrangement of claim 14, wherein the plurality of processing cores equals N processing cores, and the bit vector comprises N bits, with each bit corresponding to the coherence status of the cache associated with the N processing cores.

16. The multi-core processing arrangement of claim 13, wherein the coherence information comprises a bit vector corresponding to each cached line.

17. The multi-core processing arrangement of claim 13, further comprising a cache configuration manager for configuring at least two of said L1 data caches to operate as a single coherent shared cache, wherein the cache configuration manager specifies a hash function to determine the configuration, at least in part, by applying a hash function on a number of the processing cores.

18. The multi-core processing arrangement of claim 13, wherein the processing cores and L1 cache are provided on a single integrated circuit.

19. The multi-core processing arrangement of claim 18, wherein the L2 cache is provided on the single integrated circuit with the processing cores and L1 cache.
